(19) United States
(12) Patent Application Publication
(10) Pub. No.: US 2003/0020781 A1
(43) Pub. Date: Jan. 30, 2003

(54) Ink-jet printing module having a cleaning device and a covering device at two sides of the printing platform

(76) Inventor: Tsung-Te Lin, Sanchung City (TW)

Correspondence Address: RABIN & CHAMPAGNE, PC, 1101 14TH STREET, NW, SUITE 500, WASHINGTON, DC, 20005, US

(21) Appl. No.: 10/200,945

(22) Filed: Jul. 24, 2002

(30) Foreign Application Priority Data
Jul. 25, 2001 (TW) 90212649

(51) Int. Cl. B41J 2/165

(52) U.S. Cl. 347/33; 347/29

(57) ABSTRACT

An ink-jet printing module, positioned in an ink-jet printing mechanism, is disclosed. The ink-jet printing module has a first side, a second side opposite to the first side, and a guiding bar between the first side and the second side. The guiding bar has a first end coupled to the first side and a second end coupled to the second side. A print head is removably located at the guiding bar. The ink-jet printing module comprises: a cleaning device such as a wiper, a covering device such as a cap and a printing platform. The cleaning device for cleaning the print head is located at a bottom of the ink-jet printing module and adjacent to an interior of the first side. The covering device for covering the print head is located at the bottom of the ink-jet printing module and adjacent to an interior of the second side. The printing platform is located at the bottom of the ink-jet printing module and between the cleaning device and the covering device.

This application incorporates by reference of Taiwan application Serial No. 090212649, filed Jul. 25, 2001.

### BACKGROUND OF THE INVENTION

1. Field of the Invention

The invention relates in general to an ink-jet printing module, and more particularly to an ink-jet printing module having a cleaning device and a covering device at two sides of the printing platform.

2. Description of the Related Art

The art of ink-jet technology is relatively well developed. Commercial products such as computer printers, graphics plotters, copiers, and facsimile machines employ ink-jet technology for producing hard copy. The basics of this technology are disclosed, for example, in various articles and patents. One of the main components of the printing machine is a printing module. A conventional printing module is illustrated in FIG. 1A and FIG. 1B.

Referring to FIG. 1A and FIG. 1B, the top view and the side view of the conventional ink-jet printing module are shown, respectively. The ink-jet printing module 100 includes a print-head 102, a guiding bar 104, a printing platform 106, two sides 112a and 112b, a cleaning device 108 and a covering device 110. The side 112a and the side 112b are opposite to each other. The guiding bar 104 is located between the side 112a and the side 112b. One end of the guiding bar 104 is coupled to the side 112a and the other end of the guiding bar 104 is coupled to the side 112b. The print head 102 is removably located at the guiding bar 104 so that the print head 102 is able to move backwards and forwards in the direction indicated by the arrow 150. The bottom surface of the print head 102 is a nozzle surface 102a for ink jetting. The printing platform 106 is disposed approximately at the bottom center of the printing module 200.

During or after each printing, ink residue may remain at the nozzle surface 102a. When the ink residue accumulates to a certain amount, it may drop onto the printed document and cause contamination. If the ink residue gets dry on the nozzle surface 102a, nozzle clogging may occur. Therefore, a cleaning device 108 and a covering device 110 are necessary. The cleaning device 108 is typically a wiper to wipe away the ink residue on the nozzle surface 102a. The covering device 110 is typically a cap. The cap 110 is used for providing print head protection and preventing the nozzle from clogging by capping during non-use.

The conventional cleaning device and covering device are formed in a unitary unit, that is, a two-in-one device. The unitary cleaning and covering device is positioned adjacent to one of the two sides of the printing module 100. As a result, the space 160 between the other side 112a and printing platform 106 is left empty. Consequently, the printing module 100 as a whole is unbalanced and its sized is hard to reduce. Furthermore, even only one of the wiper and cap wears out, the whole two-in-one device needs to be replaced.

### SUMMARY OF THE INVENTION

It is therefore an object of the invention to provide an ink-jet printing module having a cleaning device and a covering device respectively at two sides of the printing platform is disclosed. In this invention, the space at the both sides of the printing platform can be effectively used. Consequently, the whole size of the printing mechanism can be reduced.

It is another object of the invention to provide an ink-jet printing module, positioned in an ink-jet printing mechanism, wherein the ink-jet printing module has a first side, a second side opposite to the first side, and a guiding bar between the first side and the second side, wherein the guiding bar has a first end coupled to the first side and a second end coupled to the second side, and wherein a print-head is removably located at the guiding bar, the ink-jet printing module comprising: a cleaning device such as a wiper, a covering device such as a cap and a printing platform. The cleaning device for cleaning the print head is located at a bottom of the ink-jet printing module and adjacent to an interior of the first side. The covering device for covering the print head is located at the bottom of the ink-jet printing module and adjacent to an interior of the second side. The printing platform is located at the bottom of the ink-jet printing module and between the cleaning device and the covering device.

The printing mechanism can be used in an ink-jet printer, an ink-jet photocopier, and an ink-jet facsimile machine.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A and FIG. 1B (Prior Art) are the top view and the side view of the conventional ink-jet printing module, respectively.

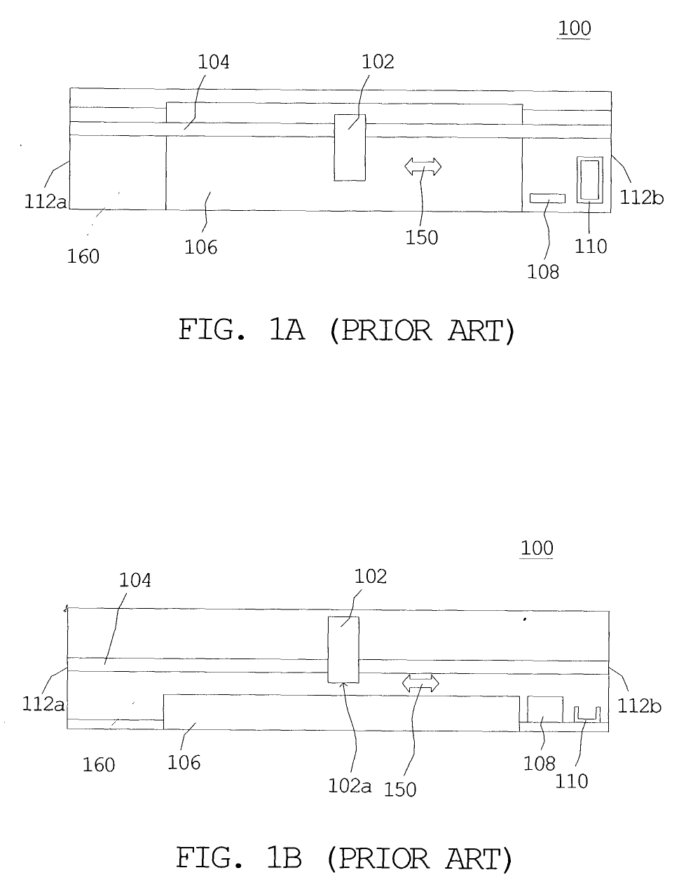

FIG. 2A and FIG. 2B are respectively the top view and the side view of the ink-jet printing module according to a preferred embodiment of the invention.

### DETAILED DESCRIPTION OF THE INVENTION

According to the spirit of the invention, an ink-jet printing module having a cleaning device and a covering device respectively at two sides of the printing platform is disclosed. In this invention, the space at the both sides of the printing platform can be effectively used. Consequently, the whole size of the printing mechanism can be reduced. The printing mechanism can be used in an ink-jet printer, an ink-jet photocopier, and an ink-jet facsimile machine. Other objects, features, and advantages of the invention will become apparent from the following detailed description of the preferred but non-limiting embodiment.

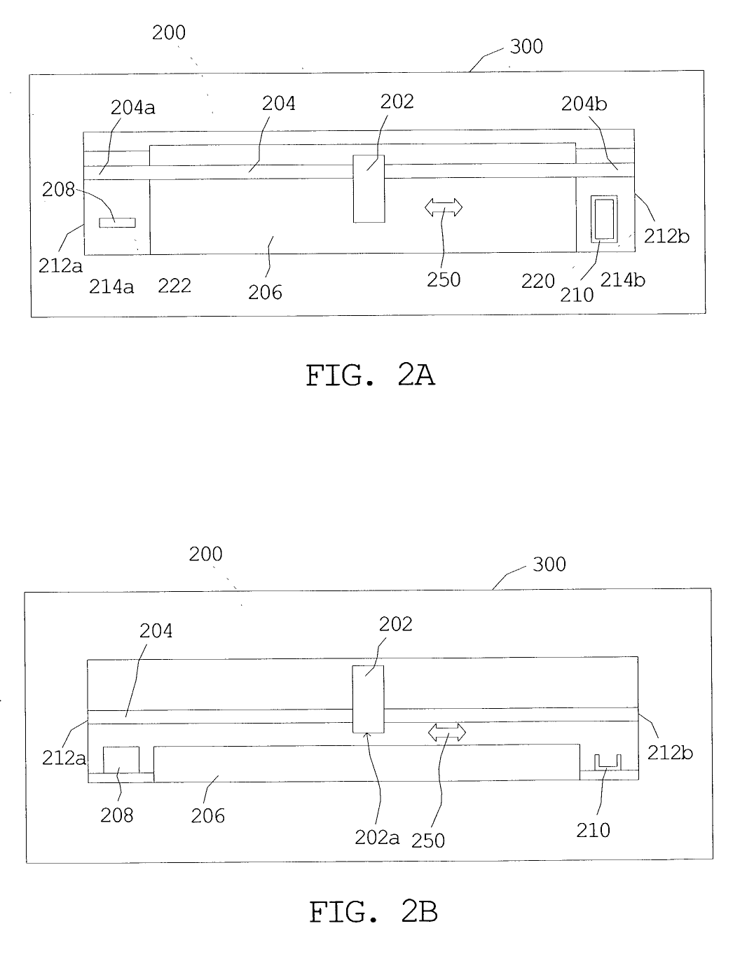

Referring to FIG. 2A and FIG. 2B, the top view and the side view of the ink-jet printing module of the invention are shown, respectively. The ink-jet printing module 200 includes a print-head 202, a guiding bar 204, a printing platform 206, two sides 212a and 212b, a cleaning device and a covering device. The side 212a is opposite to the side 212b. The guiding bar 204 is disposed between the two sides 212a and 212b, with one end 204a coupled to the interior 214a of the side 212a and the other end 204b coupled to the interior 214b of the side 212b. The print-head 202 is removably disposed at the guiding bar 204 so that the print-head 202 is able to move backwards and forwards in the direction indicated by the arrow 250. The bottom surface of the print head 202 is a nozzle surface 202a for ink jetting.

The cleaning device of the invention comprises a wiper 208. The wiper 208 is disposed at the bottom of the ink-jet printing module 200 and is adjacent to the interior 214a of the side 212a. The wiper 208 is used for wiping away the ink residue at the print head 202 after printing. Furthermore, the cleaning device comprises an ink-absorbing device, such as a sponge.

The covering device can be a cap 210. The cap 210 is disposed at the bottom of the ink-jet printing module 200 and is adjacent to the interior 214b of the side 212b. The cap 210 is used for providing print-head protection by capping and preventing the nozzle form clogging during non-use.

The printing platform 206 is disposed approximately at the bottom center of the printing module 200 and between the wiper 208 and the cap 210.

The movement of the print head 202 is briefly described as follows. Before each printing operation, the print head 202 rests at the capping region 220 and capped by the cap 210. When receiving a printing signal, the print head 202 moves to the wiping region 222. Then, the wiper 208 starts to wipe the print head 202. After that, the print head 202 is ready for printing. During the printing operation, the print head 202 moves backwards and forwards above the printing platform 206. After printing service, the print head 202 moves back to the wiping region 222 and gets cleaned by the wiper 208. Then, the print head 202 returns to the capping region 220 and is capped by the cap 210 until next printing operation.

The ink-jet printing module 200 of the invention can be installed in any ink-jet image forming machine 300, such as an ink-jet printer, an ink-jet photo-copier, an ink-jet facsimile machine and the like.

According to the ink-jet printing module of the invention, the space at the both sides of the printing platform can be effectively used. Consequently, the whole size of the printing mechanism can be reduced and the printing mechanism as a whole is more balanced. Another advantage of the invention is that when either one of the wiper and cap wears out, only the single worn-out device needs to be replaced. As to the conventional two-in-one device, even only one device, for example, the wiper, fatigues, the whole two-in-one device needs to be replaced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An ink-jet printing module, positioned in an ink-jet printing mechanism, wherein the ink-jet printing module has a first side, a second side opposite to the first side, and a guiding bar between the first side and the second side, wherein the guiding bar has a first end coupled to the first side and a second end coupled to the second side, and wherein a print-head is removably located at the guiding bar, the ink-jet printing module comprising:
a cleaning device for cleaning the print head, located at a bottom of the ink-jet printing module and adjacent to an interior of the first side;
a covering device for covering the print-head, located at the bottom of the ink-jet printing module and adjacent to an interior of the second side; and
a printing platform located at the bottom of the ink-jet printing module and between the cleaning device and the covering device.

2. The ink-jet printing module as claimed in claim 1, wherein the cleaning device comprises a wiper.

3. The ink-jet printing module as claimed in claim 1, wherein the cleaning device comprises an ink-absorbing device.

4. The ink-jet printing module as claimed in claim 1, wherein the covering device comprises a cap.

5. The ink-jet printing module as claimed in claim 1, wherein the ink-jet printing mechanism is installed in an ink-jet printer.

6. The ink-jet printing module as claimed in claim 1, wherein the ink-jet printing mechanism is installed in an ink-jet photocopier.

7. The ink-jet printing module as claimed in claim 1, wherein the ink-jet printing mechanism is installed in an ink-jet facsimile machine.

8. An ink-jet printing module, positioned in an ink-jet printing mechanism, wherein the ink-jet printing module has two sides, and a guiding bar between the two sides, and wherein a print-head is removably located at the guiding bar, the ink-jet printing module comprising:
a cleaning device for cleaning the print head, adjacent to an interior of one of the two sides;
a covering device for covering the print-head, adjacent to an interior of the other one of the two sides and opposite to the cleaning device; and
a printing platform located at the bottom of the ink-jet printing module and between the cleaning device and the covering device.

9. The ink-jet printing module as claimed in claim 8, wherein the cleaning device comprises a wiper.

10. The ink-jet printing module as claimed in claim 8, wherein the cleaning device comprises an ink-absorbing device.

11. The ink-jet printing module as claimed in claim 8, wherein the covering device comprises a cap.

12. The ink-jet printing module as claimed in claim 8, wherein the ink-jet printing mechanism is installed in an ink-jet printer.

13. The ink-jet printing module as claimed in claim 8, wherein the ink-jet printing mechanism is installed in an ink-jet photocopier.

14. The ink-jet printing module as claimed in claim 8, wherein the ink-jet printing mechanism is installed in an ink-jet facsimile machine.
